(19) United States
(12) Patent Application Publication
(10) Pub. No.: US 2007/0101776 A1
(43) Pub. Date: May 10, 2007

(54) Mortice lock

(76) Inventor: Mark Anthony Naylor, Hangzhou (CN)

Correspondence Address: KANE & CO., PLC, 5 Lyon St. N.W., 210 Commerce Building, GRAND RAPIDS, MI, 49503, US

(21) Appl. No.: 10/580,298

(22) PCT Filed: Oct. 13, 2004
(86) PCT No.: PCT/GB04/04342

§ 371 Date: May 19, 2006

(30) Foreign Application Priority Data
Nov. 21, 2003 (GB) 0327109.5

(51) Int. Cl. E05B 59/00; E05B 63/14

(52) U.S. Cl. 70/107

(57) ABSTRACT

A mortice lock having a deadbolt (16) retained within the lock case (10) and movable between an unlocking position wherein the deadbolt is contained within a lock case, and the locking position in which it extends outwardly therefrom, and a driving mechanism with a cam (18) which connects with and moves the deadbolt between its locking and unlocking positions and a pair of sliding contact members (21, 22) mounted on and slidably movable with respect to the deadbolt between a first position in which it maintains contact with the driving member to effect a full 20 mm throw of the deadbolt in one direction, and a second position to enable a full throw of the deadbolt in an opposite direction.

This invention concerns mortice locks of the type including a deadbolt which is retained within a lock case and movable between an unlocking position wherein the deadbolt is disposed within the lock case, and a locking position in which it extends outwardly from a fore-end thereof.

The invention is particularly concerned with providing a mortice lock of this kind wherein the “throw” of the deadbolt from the front or fore-end of the casing is as much as 20 mm within a standard lock case of 63.5 mm (nominal).

Conventionally, it has not been possible to construct a lock of this size with a 20 mm bolt throw using a mechanism which both extends and retracts the deadbolt in a positive manner and prevents the bolt from being pushed back manually from its outermost locking position.

In locks of this kind there is usually provided a rotary driving mechanism which may be a key, a key cam or a cylinder cam which makes contact with the deadbolt to extend and retract it during rotation of the driving mechanism. In order to ensure the maximum throw of the bolt head the driving mechanism should maintain contact with the deadbolt throughout its movement, yet allow the bolt to pass over the axis of rotation of the driving mechanism when the bolt is retracted.

According to the present invention there is provided a mortice lock including a deadbolt retained within a lock case and movable between an unlocking position wherein the deadbolt is disposed within the lock case, and a locking position in which it extends outwardly from a fore-end thereof, and a driving mechanism rotatable about an axis transverse to the direction of movement of the deadbolt and having a cam which connects with and moves the deadbolt between said positions; characterised by at least one contact member mounted on and movable with respect to the deadbolt between a first position in which the contact member maintains contact with the driving member to effect a full throw of the deadbolt in one direction, and a second position to enable a full throw of the deadbolt in an opposite direction.

The driving member may be a key.

The driving member may be cylinder cam.

The driving member may be a key cam associated with multiple levers.

Two contact members may be mounted on the deadbolt one of which maintains contact with the driving member throughout movement of the deadbolt into the locking position, the other maintaining contact with the driving member throughout movement of the deadbolt into the unlocking position.

Each contact member may be movable into a position in which it prevents movement of the deadbolt.

The or each contact member may have a cam follower residing in a track in the lock case, the track being formed to effect movement of the contact member between its first and second positions.

The deadbolt may, in its locking position, extend from the fore-end of the lock case by 20 mm.

Embodiments of the invention will now be described, by way of example only, with reference to the accompanying drawings, in which:—

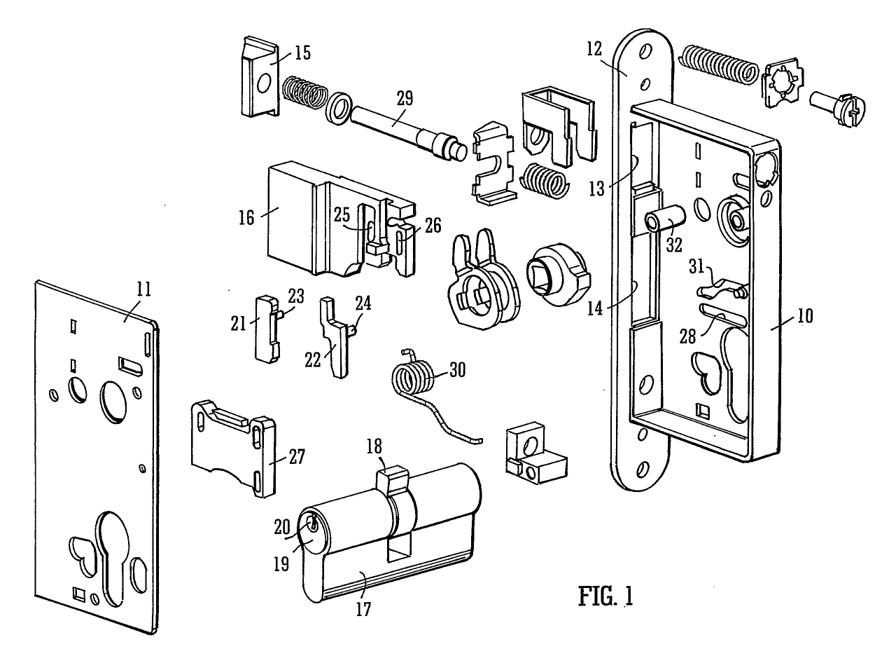

FIG. 1 is an exploded view of a mortice lock made in accordance with a first embodiment of the invention; and

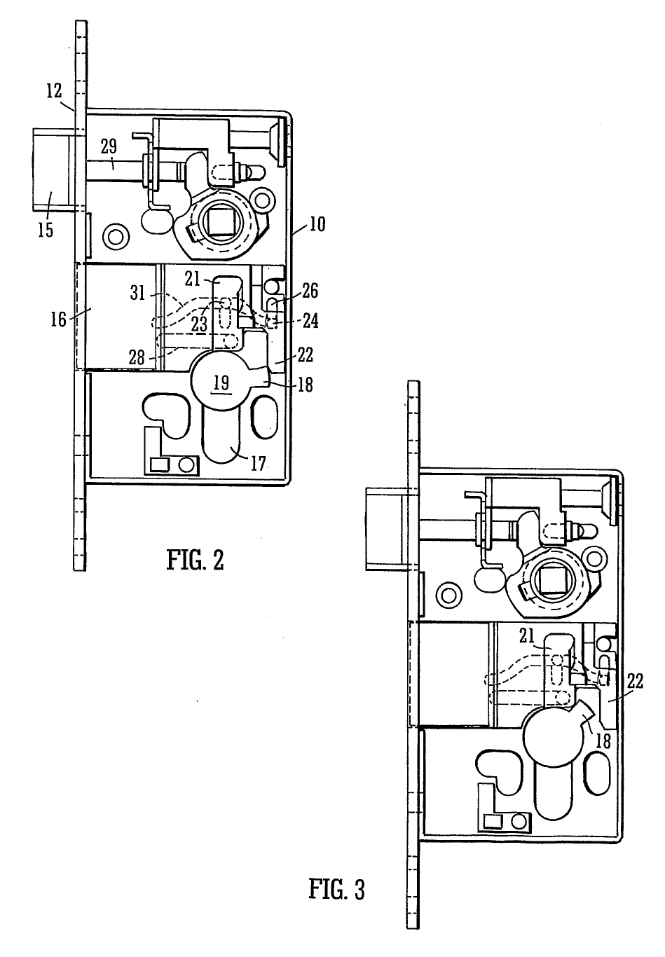

FIGS. 2 to 12 illustrate the lock of FIG. 1 assembled and showing progressive movement of the lock mechanism between an unlocking and a locking position of a deadbolt being part of the lock.

Referring now to FIG. 1, the mortice lock comprises a lock case 10, 11 having a for-end plate 12 with apertures 13 and 14 through which extend a latch 15 and a deadbolt 16 respectively.

Within the lock case 10, 11, in this example, is a cylinder lock 17 having a driving member in the form of a rotatable cam 18 which rotates about the axis of a barrel 19 which is turned by a key inserted into a slot 20.

A pair of contact members 21, 22 are slidably mounted on the deadbolt 16 having pins 23 and 24 respectively, which permit limited vertical movement within slots 25 and 26 respectively in the deadbolt 16. A dummy lever 27 moves horizontally within the lock case along with deadbolt 16 and has a pin (not shown) which rides in a horizontal track 28 in the lock case 10. The pins 23 and 24 are also constrained to ride in a curved track 31 as will be described.

The latch 15 mounted on a latch pin 29 together with appropriate springs, is normally retained in a position extending outwardly from apertures 13 but is retracted within the casing during closure of a door in which the lock is inserted. The latch mechanism itself forms no part of the present invention, being of a standard design.

A spring 30 urges the sliding contact members 21 and 22 in a downwards direction in relation to deadbolt 16 during operation of the lock.

Referring now to FIG. 2, it will be seen that the dead lock 16 is in its unlocking position wholly contained within the lock casing 10, 11 but with its forward end substantially flush with the front of the fore-end plate 12. In this position the cam 18 is in a fully unlocking position and is in contact with a lower region of the sliding contact member 22 which itself is in a lowermost position with respect to the deadbolt 16.

In this position, the other sliding contact member 21 is in its uppermost position with respect to the deadbolt 16 and is thus located overhead of the body of the cylinder cam 17.

Referring now to FIG. 3, as the cam 18 is rotated in an anti-clockwise direction in the drawing, it leaves contact with sliding contact member 22 then making contact with the lower region of the sliding contact member 21.

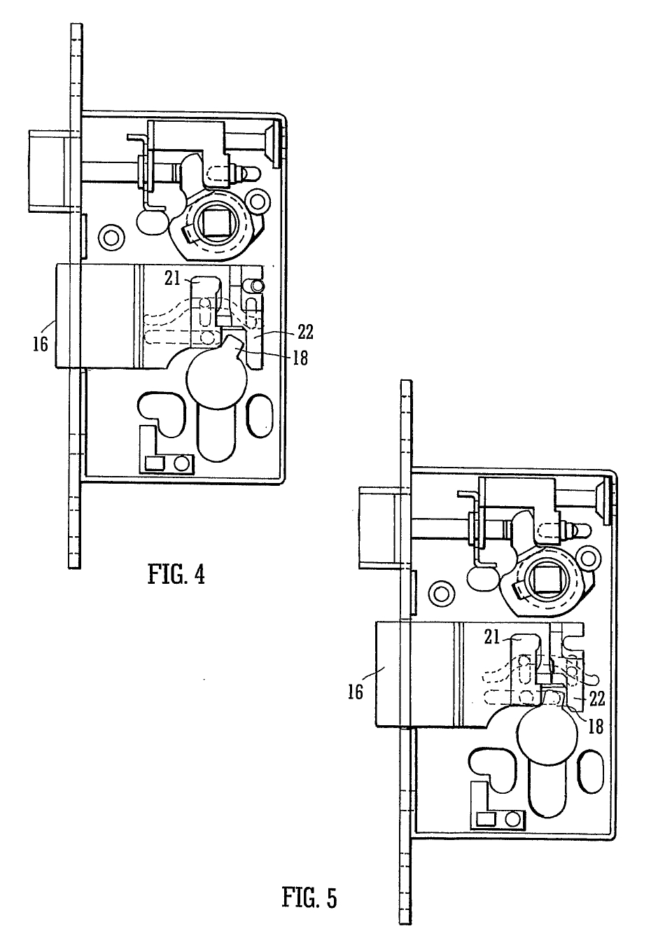

Referring now to FIG. 4 with continued rotational movement of the cam 18 it pushes the sliding contact member 21 towards the left hand side of FIG. 3 thus starting to advance the deadbolt 16 from the casing. Thus, the pin 24 of sliding contact member 22 commences its travel upwardly in the track 31 whereby the member 22 starts to rise.

FIG. 5 shows the sliding contact member 22 in a further elevated position while cam 18 continues to push against sliding contact member 21 to advance the deadbolt 16 further from the casing.

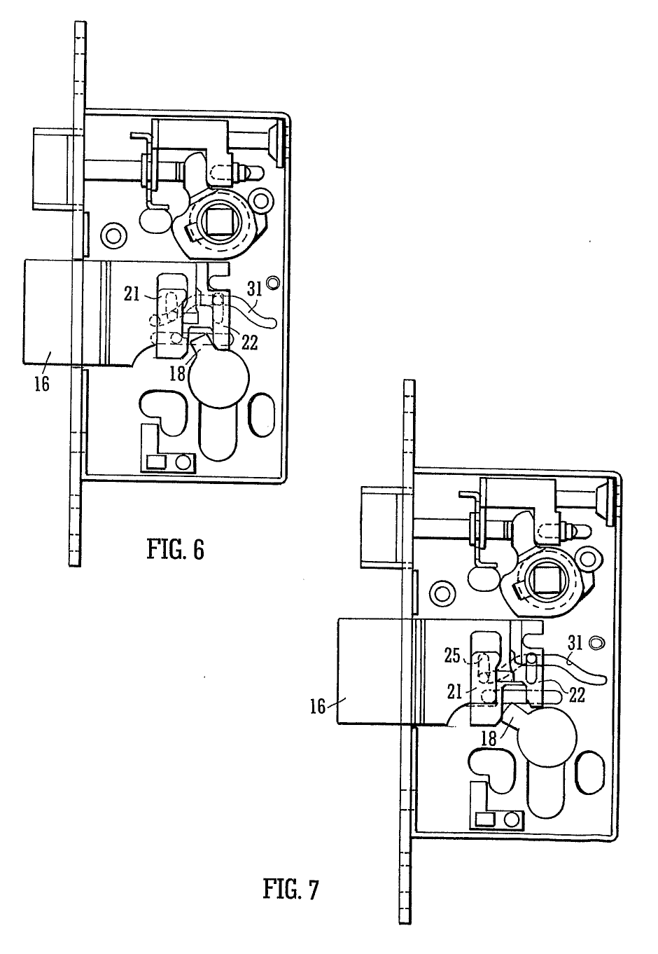

Referring now to FIG. 6 it will be seen that the sliding contact member 22 has reached its maximum height with the pin 24 at the highest point of the track 31, and in this position the sliding contact member 21 is starting to descend constrained by the track 31 while the bolt 16 continues to advance from the casing.

FIG. 7 shows the position of maximum extension of the deadbolt 16. This extension is 20 mm in the present example as required by the design of this mortice lock in a standard 63.5 mm casing. The extended throw to 20 mm is provided by continuous contact between the cam 18 and the then lowered sliding contact member 21. It will be seen also that in this position the sliding contact member 22 is at its maximum height and has therefore been permitted to ride over the top of the cylinder cam 17.

Contact of the cam 18 with the bottom of the sliding contact member 21 prevents the deadbolt 16 from being pushed back into the casing so that the 20 mm throw is maintained.

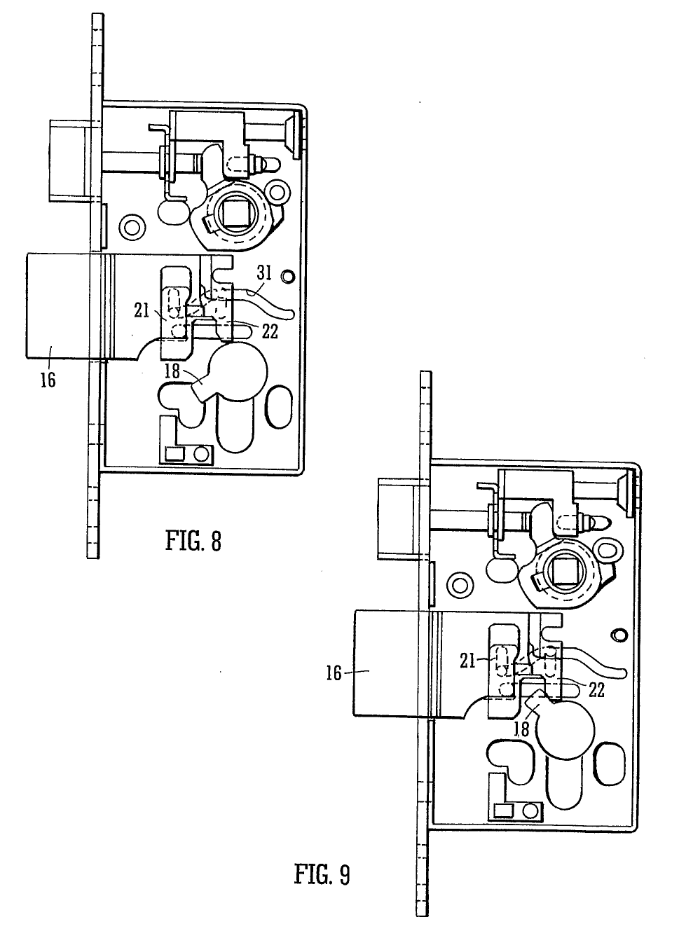

Referring now to FIG. 8, it will be seen that if the cam 18 is allowed to rotate even further in an anti-clockwise direction thus to move out of contact with the sliding contact member 21, nevertheless, the bolt cannot be pushed back very far because the sliding contact member 21 would then come into contact with the top of the body of the cylinder cam 17.

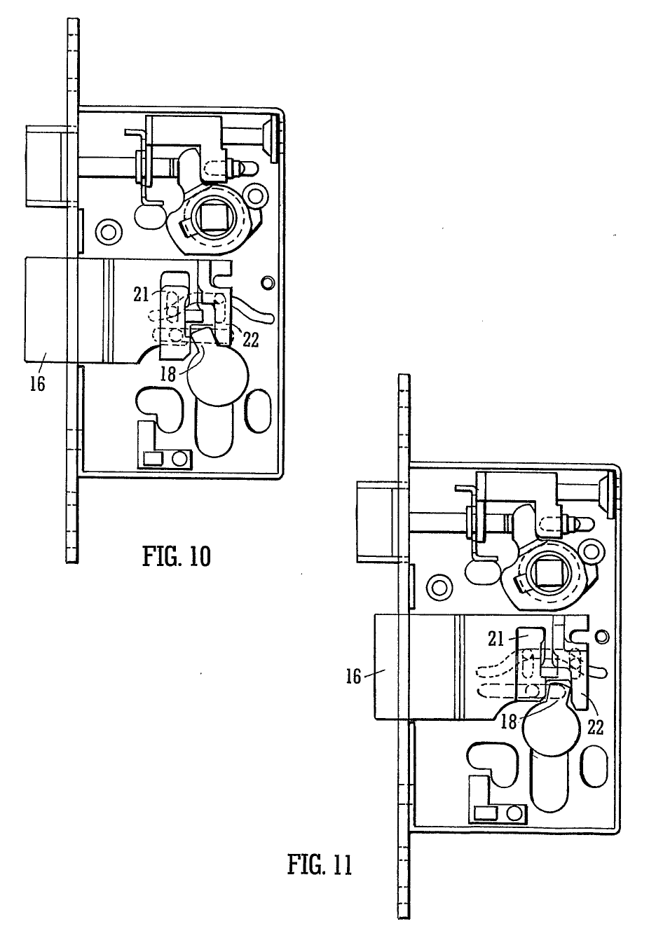

Referring now to FIG. 9, it will be seen that as the cam 18 is rotated in the clockwise direction it comes into contact with the lower end of the sliding contact member 22 to commence retracting of the deadbolt 16.

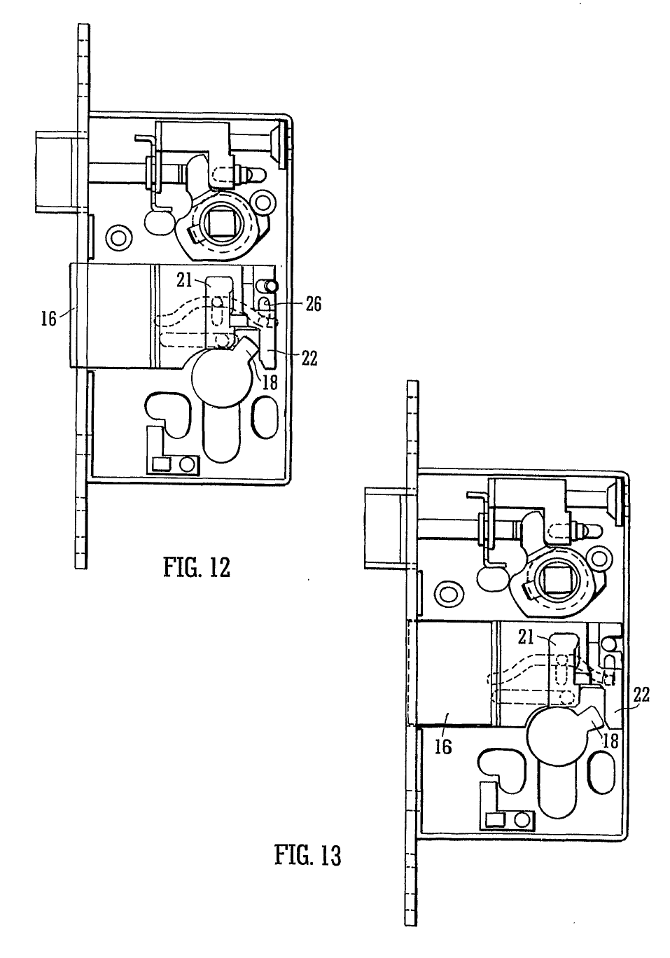

FIG. 10 shows a continuation of this movement whereupon the sliding contact member 21 rises to a point where, in FIG. 11, it may pass over the top of the body of the cylinder cam 17. Also in that position, the sliding contact member 22 is beginning to descend towards its lowermost position, and in FIG. 12 it is shown in that position such that the cam 18 will continue to push back the bolt 16 into its fully retracted position once again as shown in FIG. 12. Thus the parts are returned to their respective positions as illustrated in FIG. 2.

The spring 30 which locates over a pin 32 in the casing 10 bears against the upper edge of dummy lever 27 to urge the sliding contact members 21 and 22 into their lowermost positions. However, the sliding members are permitted to rise by pushing against the spring 30 when constrained by the track 31.

It will be appreciated that a mortice lock made in accordance with the invention ensures a maximum bolt throw by maintaining a connection between the driving mechanism and the bolt for a maximum extent of rotation of the driving mechanism, while allowing the bolt, or parts connected thereto, to rise and thus pass over the body of the driving mechanism. The arrangement further provides that the bolt cannot be pushed back when in any of its positions of extension from the lock case.

The cylinder cam 17 may be replaced by a multiple lever assembly as required for three, five or seven lever locks which provide additional security. In such an arrangement, the cam 18 is replaced by a key cam which receives the forward end of the key and is rotated by it.

In a simplified embodiment a key itself may advance and retract the deadbolt by direct contact with the sliding contact members 21 and 22.

The contact members may be rotatably or otherwise movable with respect to the bolt 16 thus to extend the range of contact between the cam 18 and the bolt 16, to provide the extended bolt throw in accordance with the invention.

The contoured track 31 in the casing may be replaced by wedges or other abutment means mounted in the casing and contacted by the contact members.

1. A mortice lock including a deadbolt retained within a lock case and movable between an unlocking position wherein the deadbolt is disposed within the lock case, and a locking position in which it extends outwardly from a fore-end thereof, and a driving mechanism rotatable about an axis transverse to the direction of movement of the deadbolt and having a cam which connects with and moves the deadbolt between said positions;
characterised by at least one contact member mounted on and movable with respect to the deadbolt between a first position in which the contact member maintains contact with the driving member to effect a full throw of the deadbolt in one direction, and a second position to enable a full throw of the deadbolt in an opposite direction.

2. A mortice lock according to claim 1, wherein the driving member is a key.

3. A mortice lock according to claim 1, wherein the driving member is a cylinder cam.

4. A mortice lock according to claim 1, wherein the driving member is a key cam associated with multiple levers.

5. A mortice lock according to claim 1, including two contact members mounted on the deadbolt, one of which maintains contact with the driving member throughout the movement of the deadbolt into the locking position, the other maintaining contact with the driving member throughout the movement of the deadbolt into the unlocking position.

6. A mortice lock according to claim 1, wherein the or each contact member is movable into a position in which it prevents movement of the deadbolt.

7. A mortice lock according to claim 1, wherein the or each contact member has a cam follower residing in a track in the lock case, the track being formed to effect movement of the contact member between its first and second positions.

8. A mortice lock according to claim 1, wherein the deadbolt, in its locking position, extends from the fore-end of the lock case by at least 20 mm.

9. A mortice lock according to claim 1, in which the or each contact member is slidably mounted on the deadbolt and has a pin which permits limited vertical movement within a slot in the deadbolt.

10. A mortice lock according to claim 1, including a dummy lever which is adapted to move horizontally within the lock case along with the deadbolt and has a pin which rides in a horizontal track in the lock case.

11. A mortice lock according to claim 1, including a spring located to urge the or each contact member in a downwards direction in relation to the deadbolt during operation of the lock.

12. A mortice lock according to claim 1, wherein the or each contact member is rotatably movable with respect to the deadbolt to extend the range of contact between the driving member and the deadbolt.

13. A mortice lock according to claim 1, including at least one wedge mounted in the casing and contacted by the or each contact member thus to effect movement thereof relative the deadbolt.
